(19) United States
(12) Patent Application Publication
(10) Pub. No.: US 2010/0073328 A1
(43) Pub. Date: Mar. 25, 2010

(54) ANISOTROPIC OPTICAL COVER FOR TOUCH PANEL DISPLAY

(76) Inventors: Brian Lynch, Portoloa Valley, CA (US); Richard Hung Minh Dinh, San Jose, CA (US); Jeffrey Traer Bernstein, San Francisco, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(21) Appl. No.: 12/238,339

(22) Filed: Sep. 25, 2008

(51) Int. Cl. G06F 3/042; G02F 1/1335

(52) U.S. Cl. 345/175; 349/12

(57) ABSTRACT

A touch panel display configured to improve touch panel detection for sensor panels embedded in display modules. Touch panel detection can be improved by arranging an optically anisotropic cover over a display module within which an optical sensor panel is embedded. Since the optically anisotropic cover comprises light-guiding channels through which light is guided by total internal reflection, the cover can effectively shift the sensor plane from an outer surface of the cover, near the location of an object to be detected, to an inner surface of the cover, near the location of the sensor panel. In additional, the optically anisotropic cover can effectively shift the image plane from the inner surface of the cover, near the display module, to the outer surface of the cover, near the viewing surface.

### FIELD OF THE INVENTION

This relates generally to touch panels used as input devices for computing systems, and more particularly, to improving touch panel detection for touch sensor panels embedded in display modules.

### BACKGROUND OF THE INVENTION

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

However, the positioning of a display device behind a touch sensor panel in a touch screen can present certain issues. For example, although touch sensor panels are constructed of clear materials, the clarity of a displayed image can be negatively impacted when transmitted through such materials. In addition, the touch sensor panel can contribute increased thickness to the display area of the computing system.

### SUMMARY OF THE INVENTION

A touch panel display configured to improve touch panel detection for sensor panels embedded in display modules is disclosed. Touch panel detection according to embodiments of the invention can be improved by arranging an optically anisotropic cover over a display module within which an optical sensor panel is embedded.

Since the optically anisotropic cover comprises light-guiding channels through which light is guided by total internal reflection, the cover can effectively shift the sensor plane from an outer surface of the cover, near the location of an object to be detected, to an inner surface of the cover, near the location of the sensor panel. In additional, the optically anisotropic cover can effectively shift the image plane from the inner surface of the cover, near the display module, to the outer surface of the cover, near the viewing surface.

This enables the cover to be provided with varying shapes and sizes with minimal loss of sensor resolution (due to varying cover thicknesses separating an object from a sensor for example) and image quality (due to lensing effects associated with curved surfaces, for example).

In one embodiment, the cover can be formed of a fiber optic bundle. In another embodiment, the cover can be formed of an anisotropic material, such as Ulexite for example. In a further embodiment, the cover can be formed by creating microholes in a substrate having a particular refractive index, and filling the microholes with a material having a higher refractive index.

### BRIEF DESCRIPTION OF THE DRAWINGS

FIGS. 1A-1C illustrate an exemplary sensing display module with an anisotropic cover according to one embodiment of the invention.

FIG. 2 illustrates an exemplary sensing liquid crystal display (LCD) module with an anisotropic cover according to one embodiment of the invention.

FIGS. 3A and 3B illustrate exemplary light-guiding channel arrangements for a sensing display module according to embodiments of the invention.

FIGS. 4A and 4B illustrate exemplary non-planar anisotropic display module covers according to embodiments of the invention.

FIG. 5 illustrates an exemplary computing system including a touch sensing display device according to embodiments of the invention

FIG. 6A illustrates an exemplary mobile telephone having a touch sensing display device according to embodiments of the invention.

FIG. 6B illustrates an exemplary digital media player having a touch sensing display device according to embodiments of the invention.

FIG. 6C illustrates an exemplary personal computer having a touch sensing display device according to embodiments of the invention.

### DETAILED DESCRIPTION OF THE PREFERRED EMBODIMENTS

In the following description of preferred embodiments, reference is made to the accompanying drawings where it is shown by way of illustration specific embodiments in which the invention can be practiced. It is to be understood that other embodiments can be used and structural changes can be made without departing from the scope of the embodiments of this invention.

Embodiments of the invention relate to improving touch panel detection for sensor panels embedded in display modules. Touch panel detection can be improved by arranging an optically anisotropic cover over a display module within which an optical sensor panel is embedded. Since the optically anisotropic cover comprises light-guiding channels through which light is guided by total internal reflection, the cover can effectively shift the sensor plane from an outer surface of the cover, near the location of an object to be detected, to an inner surface of the cover, near the location of the sensor panel. In additional, the optically anisotropic cover can effectively shift the image plane from the inner surface of the cover, near the display module, to the outer surface of the cover, near the viewing surface.

Although some embodiments of this invention may be described and illustrated herein in terms of a display device associated with a portable electronic device, it should be understood that embodiments of this invention are not so limited, but are generally applicable to a touch sensitive display device associated with any structure, such as automated teller machines (ATMs), kiosks/information booths, signature pads, automated check-in terminals at airports, automated check-out machines at retail stores, etc.

Multi-touch touch-sensitive panels according to one embodiment of this invention can detect multiple touches (touch events or contact points) that occur at about the same time (and at different times), and identify and track their locations. Touch sensor panels are disclosed in U.S. application Ser. No. 11/649,998, filed Jan. 3, 2007 and entitled “PROXIMITY AND MULTI-TOUCH SENSOR DETECTION AND DEMODULATION,” the contents of which are incorporated herein by reference in its entirety for all purposes.

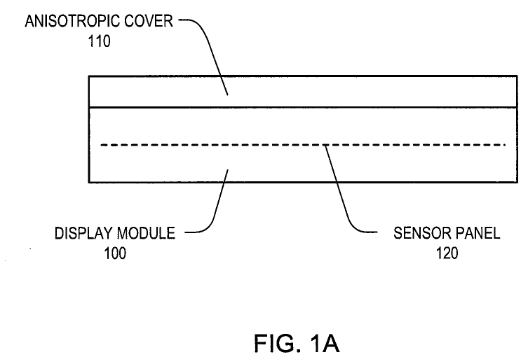

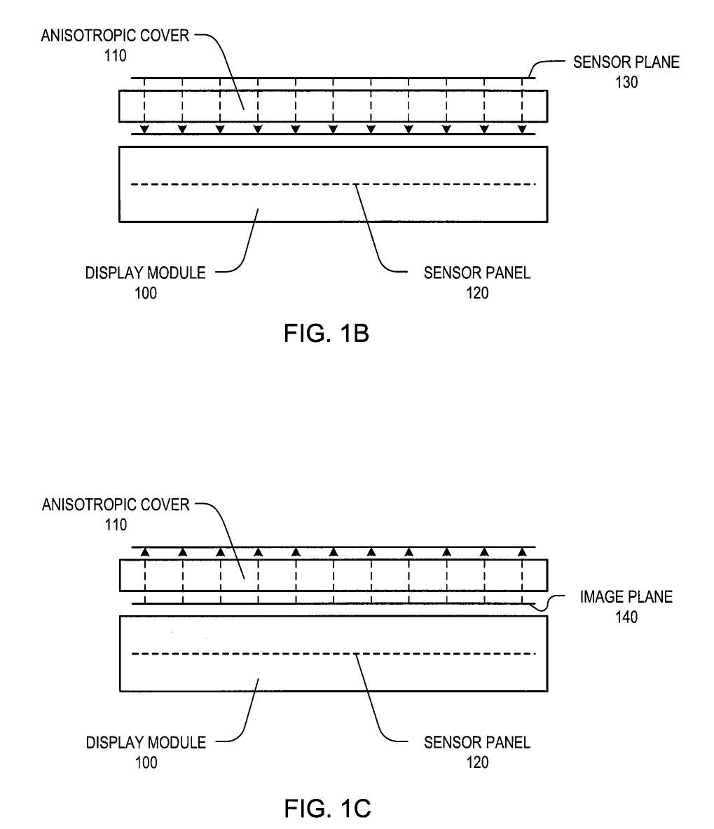

FIGS. 1A-1C illustrate display module 100 with anisotropic cover 110. Sensor panel 120 can be embedded within display module 100, and comprise optical sensors for detecting an object in contact with or in proximity to an outer surface of cover 110. Cover 110 can comprise an optically anisotropic configuration, such that light is guided through light-guiding channels of cover 110 by total internal reflection. In one embodiment, cover 110 can be formed of a fiber optic bundle. In another embodiment, cover 110 can be formed of an anisotropic material, such as Ulexite for example. In a further embodiment, cover 110 can be formed by creating microholes in a substrate having a particular refractive index, and filling the microholes with a material having a higher refractive index.

As illustrated in FIG. 1B, the optically anisotropic properties of cover 110 enable sensor plane 130 to be shifted from an outer surface of cover 110, near the location of an object to be detected, to an inner surface of cover 110, near the location of sensor panel 120. This shifting of the sensor plane increases the sensor resolution of sensor panel 120 since the light-guiding channels ensure that only light incident to a particular location on the outer surface of cover 110 can be transmitted to a corresponding location on the inner surface of cover 110. From the perspective of sensor panel 120, an object touching the outer surface of cover 110 blocks substantially the same amount of light from reaching sensor panel 120 as would be blocked if the object touched the upper surface of display module 100 directly. In this manner, cover 110 enables covers of varying thicknesses to be arranged over display module 100 with minimal loss of sensor resolution.

Similarly, as illustrated in FIG. 1C, the optically anisotropic properties of cover 110 enable image plane 140 to be shifted from the inner surface of cover 110, near display module 100, to the outer surface of cover 110, near the viewing surface. This shifting of the image plane removes the appearance of depth that can be associated with clear glass or plastic cover layers, for example, since the light-guiding channels of cover 110 ensure that only light incident to a particular location on the inner surface of cover 110 can be transmitted to a corresponding location on the outer surface of cover 110. From the perspective of a person viewing cover 110, an image displayed from display module 100 and transmitted through cover 110 looks substantially the same when viewed on the outer surface of cover 110 as it would if viewed on the upper surface of display module 100. In this manner, cover 110 enables covers of varying thicknesses to be arranged over display module 100 with minimal loss of image quality.

It is noted that the illustrations in FIGS. 1B and 1C have been exaggerated to better demonstrate the shifting of sensor plane 130 and image plane 140 due to cover 110. For example, cover 110 is shown to be slightly separated from, rather than in contact with, display module 100. Similarly, sensor plane 130 and image plane 140 are shown to be slightly separated from, rather than coincident with, the respective surfaces of cover 110.

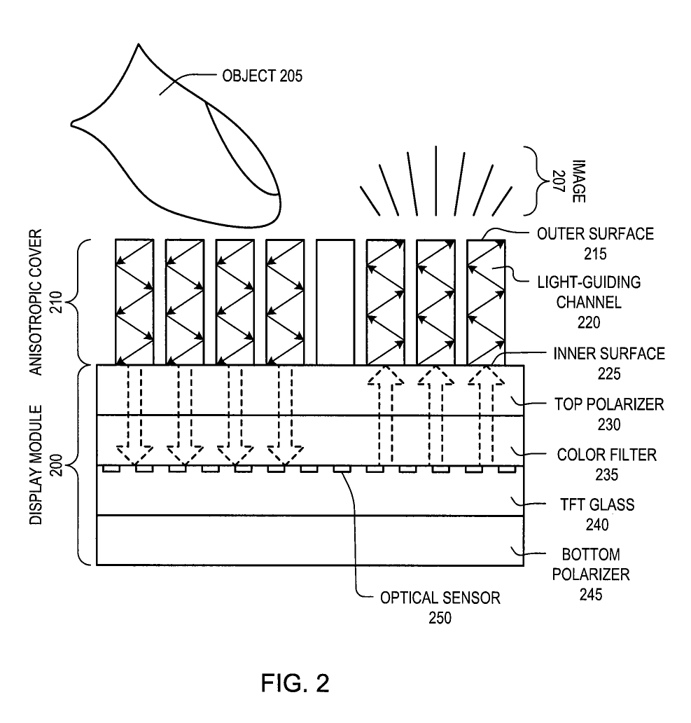

FIG. 2 illustrates a sensing LCD display module 200 with anisotropic cover 210. Display module 200 can include top polarizer 225, color filter 235, thin film transistor (TFT) glass 240 and bottom polarizer 245. Liquid crystals (not shown) and an array of optical sensors 250, such as photo sensors for example, can be disposed between TFT glass 240 and color filter 235 and arranged in pixels. The liquid crystals can be manipulated by TFTs (not shown) mounted on TFT glass 240 to generate images, and optical sensors 250 can detect an amount of light to detect whether object 205 is in contact with or in proximity to outer surface 215 of cover 210.

The upward-facing arrows on the right side of display module 200 and anisotropic cover 210 illustrate the shifting of image 207, generated by display module 200, from inner surface 225 of cover 210 to outer surface 215 of cover 210 via light-guiding channels 220. Similarly, the downward-facing arrows on the left side of display module 200 and anisotropic cover 210, under object 205, illustrate the shifting of a sensor plane from outer surface 215 of cover 210 to inner surface 225 of cover 210 via light-guiding channels 220.

It is noted that the illustration in FIG. 2 has been exaggerated to better demonstrate the shifting of the sensor plane and image planes due to cover 210. For example, the width of light-guiding channels has been oversized for illustration purposes, and only one direction, rather than both directions, of transmitted light are illustrated in light-guiding channels 220.

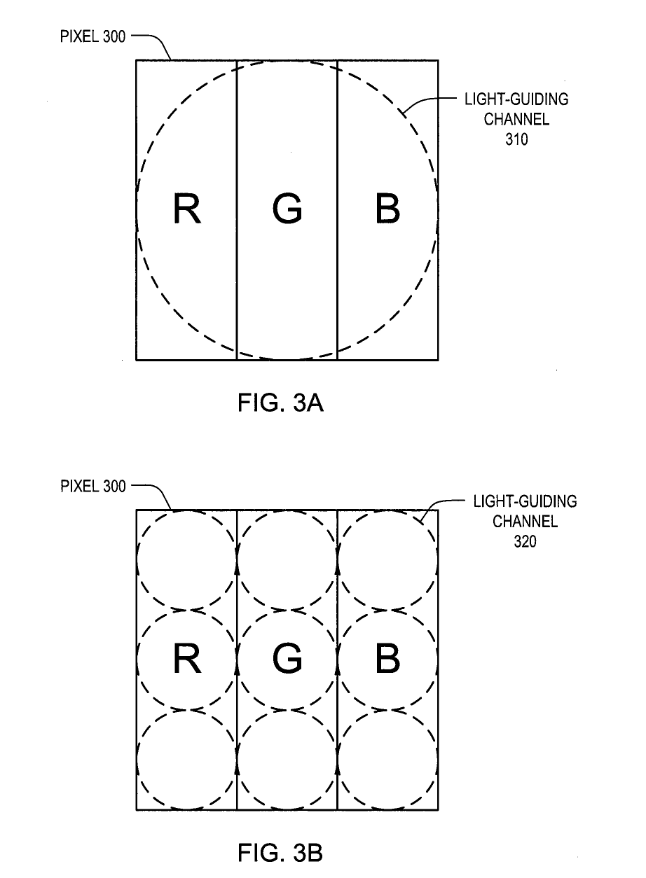

FIGS. 3A and 3B illustrate various light-guiding channel arrangements for pixel 300 of a sensing display module according to the teachings of the present invention. In one embodiment for example, as illustrated in FIG. 3A, an optically isotropic cover according to the teachings of the present invention can include light-guiding channels 310 configured such that the width of a single channel 310 is similar to that of pixel 300, and arranged such that each light-guiding channels 310 covers one pixel. In another embodiment, as illustrated in FIG. 3B, an optically isotropic cover according to the teachings of the present invention can include light-guiding channels 320 configured such that the width of a single channel 320 is less than that of pixel 300, and arranged such that more than one light-guiding channel 320 cover each pixel. Optical resolution can be optimized by increasing the ratio of light-guiding channels per pixel.

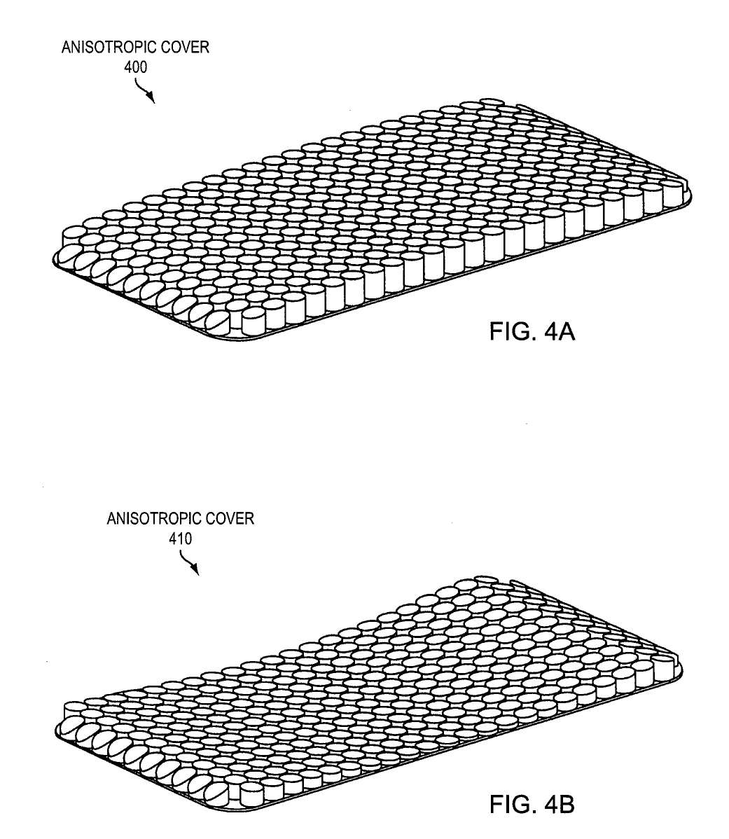

FIGS. 4A and 4B illustrate optically anisotropic covers that have non-planar outer surfaces. In one embodiment for example, as illustrated in FIG. 4A, anisotropic cover 400 is configured with an outward curvature on its outer surface. In another embodiment, as illustrated in FIG. 4B, anisotropic cover 410 is configured with an inward curvature on its outer surface. Since optically anisotropic layers covering sensing display modules can shift sensor and image planes as described above, such covers can be provided with varying shapes and sizes with minimal loss of sensor resolution (due to varying cover thicknesses separating an object from a sensor for example) and image quality (due to lensing effects associated with curved surfaces, for example).

An optically anisotropic cover in accordance with the teachings of the present invention can coupled to a sensing display module in any suitable manner, such as by lamination or bonding for example. In one embodiment, the cover can constitute a protective layer for the sensing display module and form the external surface of the device or structure into which the sensing display module is incorporated. In another embodiment, a protective layer can be placed over and conform to the optically anisotropic cover.

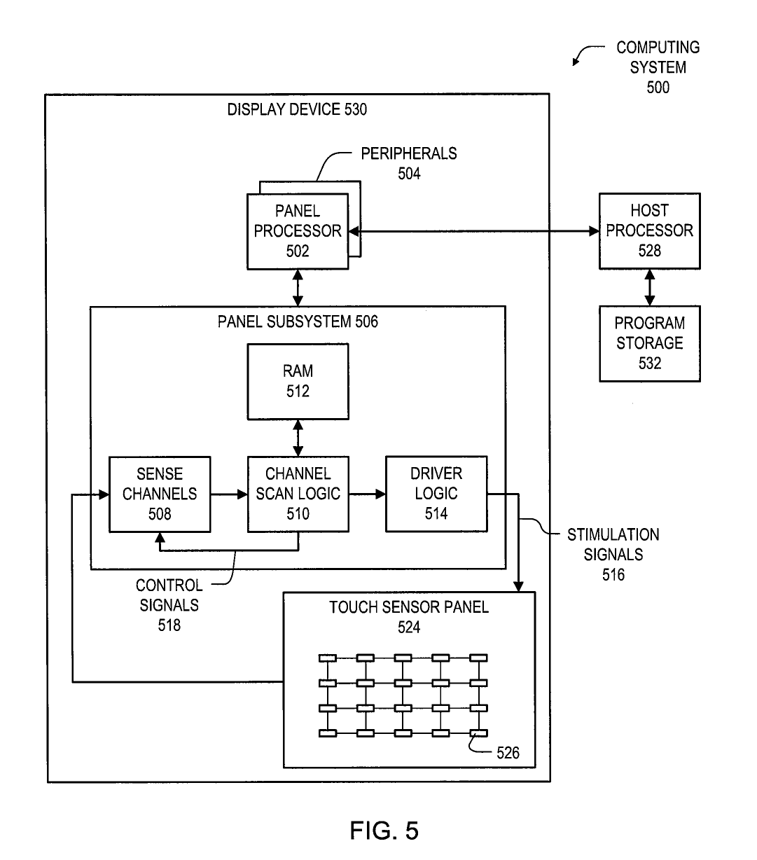

FIG. 5 illustrates exemplary computing system 500 that can include one or more of the embodiments of the invention described above. Computing system 500 can include touch sensing display device 530 comprising a display such as an LCD and one or more panel processors 502, peripherals 504 and panel subsystem 506. Peripherals 504 can include, but are not limited to, random access memory (RAM) or other types of memory or storage, watchdog timers and the like. Panel subsystem 506 can include, but is not limited to, one or more sense channels 508, channel scan logic 510 and driver logic 514. Channel scan logic 510 can access RAM 512, autonomously read data from the sense channels and provide control signals 518 for the sense channels. In addition, channel scan logic 510 can control driver logic 514 to generate stimulation signals 516 that can be selectively applied to drive lines of touch sensor panel 524. In some embodiments, panel subsystem 506, panel processor 502 and peripherals 504 can be integrated into a single application specific integrated circuit (ASIC).

Touch sensor panel 524 can be embedded within a display module of the display device 530 and include an optical sensing medium having a plurality of drive lines and a plurality of sense lines, although other sensing configurations can also be used. Each intersection of drive and sense lines can represent an optical sensing node and can be viewed as picture element (pixel) 526, which can be particularly useful when touch sensor panel 524 is viewed as capturing an “image” of touch. (In other words, after panel subsystem 506 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel). Each sense line of touch sensor panel 524 can drive sense channel 508 in panel subsystem 506. The display module of display device 530 can be covered with an anisotropic cover to shift the sensor image plane closer to the embedded sensor panel according to embodiments of the invention.

Computing system 500 can also include host processor 528 for receiving outputs from panel processor 502 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 528 can also perform additional functions that may not be related to panel processing, and can be coupled to program storage 532 and display device 530 for providing a UI to a user of the device. Touch sensing display device 530 together with an anisotropic cover layer can form a touch screen.

Note that one or more of the functions described above can be performed by firmware stored in memory (e.g. one of the peripherals 504 in FIG. 5) and executed by panel processor 502, or stored in program storage 532 and executed by host processor 528. The firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

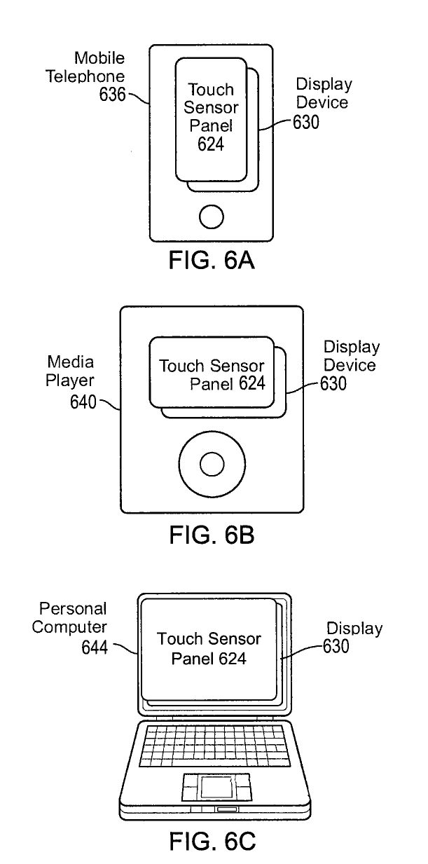

FIG. 6A illustrates exemplary mobile telephone 636 that can include touch sensing display device 630 with embedded touch sensor panel 624, the touch sensing display device covered with an anisotropic layer to shift the sensor image plane closer to the embedded sensor panel according to embodiments of the invention.

FIG. 6B illustrates exemplary digital media player 640 that can include touch sensing display device 630 with embedded touch sensor panel 624, the touch sensing display device covered with an anisotropic layer to shift the sensor image plane closer to the embedded sensor panel according to embodiments of the invention.

FIG. 6C illustrates exemplary personal computer 644 that can include touch sensing display device 630 with embedded touch sensor panel 624, the touch sensing display device covered with an anisotropic layer to shift the sensor image plane closer to the embedded sensor panel according to embodiments of the invention.

The mobile telephone, media player and personal computer of FIGS. 6A, 6B and 6C can achieve improved touch panel detection by utilizing an anisotropic cover layer according to embodiments of the invention.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A computing device comprising:
a display module;
a plurality of optical sensors embedded within the display module; and
an optically anisotropic cover arranged over the display module.

2. The computing device of claim 1, wherein the cover is formed of a fiber optic bundle.

3. The computing device of claim 1, wherein the cover is formed of an anisotropic material.

4. The computing device of claim 3, wherein the anisotropic material comprises Ulexite.

5. The computing device of claim 1, wherein the cover includes an inner planar surface and an outer non-planar surface.

6. The computing device of claim 5, wherein the inner planar surface of the cover conforms to a surface of the display module.

7. The computing device of claim 5, wherein the outer non-planar surface of the cover conforms to the external surface of the computing device.

8. The computing device of claim 5, wherein the outer non-planar surface of the cover comprises the external surface of the computing device.

9. A method, comprising:
covering a display module with an optically anisotropic layer; and
detecting an object in contact with or in proximity to an outer surface of the layer with a sensor embedded in a display module.

10. The method of claim 9, wherein the layer is formed of a fiber optic bundle.

11. The method of claim 9, wherein the layer is formed of an anisotropic material.

12. The method of claim 11, wherein the anisotropic material comprises Ulexite.

13. The method of claim 9, wherein the outer surface of the layer is non-planar.

14. A liquid crystal display comprising:
a first polarizer and a second polarizer;
a sensor panel and liquid crystal arranged between the first polarizer and the second polarizer; and
a cover arranged over one of the polarizers and comprising light-guiding channels through which light is guided by total internal reflection.

15. The display of claim 14, wherein the cover is formed of a fiber optic bundle.

16. The display of claim 14, wherein the cover is formed of an anisotropic material.

17. The display of claim 16, wherein the anisotropic material comprises Ulexite.

18. The display of claim 14, wherein the cover includes an outer non-planar surface.

19. A mobile telephone comprising:
a display module;
a plurality of optical sensors embedded within the display module; and
an optically anisotropic cover arranged over the display module.

20. A portable media player comprising:
a display module;
a plurality of optical sensors embedded within the display module; and
an optically anisotropic cover arranged over the display module.

21. A personal computer comprising:
a display module;
a plurality of optical sensors embedded within the display module; and
an optically anisotropic cover arranged over the display module.
